(19) United States
(12) Patent Application Publication
(10) Pub. No.: US 2024/0274335 A1
(43) Pub. Date: Aug. 15, 2024

(54) SmFeN-BASED ANISOTROPIC MAGNETIC POWDER AND BONDED MAGNET, AND PRODUCTION METHODS THEREOF

(71) Applicant: NICHIA CORPORATION, Anan-shi (JP)

(72) Inventor: Hisashi MAEHARA, Itano-gun (JP)

(73) Assignee: NICHIA CORPORATION, Anan-shi (JP)

(21) Appl. No.: 18/568,702

(22) PCT Filed: Jun. 2, 2022
(86) PCT No.: PCT/JP2022/022451

§ 371 Date: Dec. 8, 2023

(30) Foreign Application Priority Data
Jun. 10, 2021 (JP) 2021-097488

(51) Int. Cl. H01F 1/059; B22F 1/05; B22F 1/10; B22F 1/145; B22F 9/22; C22C 38/00; C22C 38/12; C23C 8/26

(52) U.S. Cl. CPC H01F 1/059; B22F 1/05; B22F 1/10; B22F 1/147; B22F 9/22; C22C 38/001; C22C 38/005; C22C 38/12; C23C 8/26; B22F 2301/355; B22F 2304/10; B22F 2998/10; B22F 2999/00; C22C 2202/02

(57) ABSTRACT

To provide a SmFeN-based anisotropic magnetic powder having excellent magnetic properties and a low oxygen content, and a production method thereof. A method of producing a SmFeN-based anisotropic magnetic powder includes preparing a SmFeN-based anisotropic magnetic powder before dispersion containing Sm, Fe, and N; and dispersing the SmFeN-based anisotropic magnetic powder before dispersion using resin-coated metal media or resin-coated ceramic media. The SmFeN-based anisotropic magnetic powder contains Sm, Fe, and N and has an average particle size in a range from 2.5 μm to 5 μm, a residual magnetization σr of 150 emu/g or more, and an oxygen content of 0.4 mass % or less.

### TECHNICAL FIELD

The present disclosure relates to a SmFeN-based anisotropic magnetic powder and a bonded magnet, and production methods thereof.

### BACKGROUND ART

Patent Document 1 discloses a method in which a SmFeN-based anisotropic magnetic powder is ground using ceramic media in a solvent. However, when hard ceramic media are used, fine particles may presumably be generated due to chipping, which increases the oxygen content in the SmFeN-based anisotropic magnetic powder formed after grinding and degrades the magnetic properties thereof.

### CITATION LIST

### Patent Literature

Patent Document 1: JP 2015-195326 A

### SUMMARY OF INVENTION

### Technical Problem

Regarding a SmFeN-based anisotropic magnetic powder and a production method thereof according to one embodiment of the present disclosure, it is an object to provide a SmFeN-based anisotropic magnetic powder having excellent magnetic properties and a low oxygen content, and a production method thereof. Regarding a bonded magnet and a production method thereof according to one embodiment of the present disclosure, it is an object to provide a bonded magnet using such a SmFeN-based anisotropic magnetic powder and a production method thereof.

### Solution to Problem

A method of producing a SmFeN-based anisotropic magnetic powder, according to one embodiment of the present disclosure, includes: preparing a SmFeN-based anisotropic magnetic powder before dispersion containing Sm, Fe, and N; and dispersing the SmFeN-based anisotropic magnetic powder before dispersion using resin-coated metal media or resin-coated ceramic media.

A method of producing a bonded magnet, according to one embodiment of the present disclosure, includes: forming a SmFeN-based anisotropic magnetic powder by the above-described method; and mixing the SmFeN-based anisotropic magnetic powder with a resin.

An SmFeN-based anisotropic magnetic powder according to one embodiment of the present disclosure contains Sm, Fe, and N and has an average particle size in a range from 2.5 μm to 5 μm, a residual magnetization σr of 150 emu/g or more, and an oxygen content of 0.4 mass % or less.

A bonded magnet according to one embodiment of the present disclosure contains the above-described SmFeN-based anisotropic magnetic powder and a resin.

### Advantageous Effects of Invention

With a SmFeN-based anisotropic magnetic powder and a production method thereof according to one embodiment of the present disclosure, a SmFeN-based anisotropic magnetic powder having excellent magnetic properties and a low oxygen content, and a production method thereof can be provided. Also, with a bonded magnet and a production method thereof according to one embodiment of the present disclosure, a bonded magnet using such a SmFeN-based anisotropic magnetic powder, and a production method thereof can be provided.

### BRIEF DESCRIPTION OF DRAWINGS

FIG. 1 is a SEM image of a magnetic powder prepared in Example 1.

FIG. 2 is a SEM image of a magnetic powder prepared in Example 2.

FIG. 3 is a SEM image of a magnetic powder prepared in Comparative Example 1.

FIG. 4 is a SEM image of a magnetic powder prepared in Comparative Example 2.

### DESCRIPTION OF EMBODIMENTS

Embodiments of the present disclosure will be described below. The following embodiments are, however, examples for embodying the technical concept of the present disclosure, and are not intended to limit the present disclosure. Note that in the present specification, the word “step” includes not only an independent step, but also a step that cannot be clearly distinguished from another step if the anticipated purpose of the step is achieved. Also, a numerical range indicated using “to” indicates a range including the numerical values before and after “to” as the minimum value and the maximum value, respectively.

A method of producing a SmFeN-based anisotropic magnetic powder of the present embodiment includes a step of dispersing a SmFeN-based anisotropic magnetic powder containing Sm, Fe, and N using resin-coated metal media or resin-coated ceramic media. The method of producing a SmFeN-based anisotropic magnetic powder of the present embodiment includes a step of preparing a SmFeN-based anisotropic magnetic powder before dispersion containing Sm, Fe, and N. In the dispersion step, this SmFeN-based anisotropic magnetic powder before dispersion is dispersed using the media.

### Dispersion Step

In the dispersion step, the SmFeN-based anisotropic magnetic powder containing Sm, Fe, and N is dispersed using resin-coated metal media or resin-coated ceramic media. The term “dispersion” as used herein means that aggregated particles generated by sintering or aggregated particles generated by magnetic aggregation contained in the SmFeN-based anisotropic magnetic powder are separated into single particles or particles composed of a small number of particles (hereinafter also referred to as “single particles”). According to the present embodiment, when resin-coated metal media or resin-coated ceramic media collide with the SmFeN-based anisotropic magnetic powder, the collision energy is smaller than that of the case in which non-resin-coated metal media or non-resin-coated ceramic media collide with the SmFeN-based anisotropic magnetic powder, and thus dispersion is more likely to occur than grinding. When the SmFeN-based anisotropic magnetic powder is ground in a conventional manner, the average particle size is significantly reduced, and at the same time, fine particles are also generated due to chipping; thus, reduction in magnetic properties is likely to occur. In addition, since highly active newly formed surfaces are generated on the fine particles and the original portions in which the fine particles are generated, oxidation is likely to occur, and the oxygen content is likely to increase. In contrast, when dispersion is performed as in the present embodiment, it is presumable that the generated single particles are easily oriented in a magnetic field, and thus the magnetic properties are enhanced, and the generation of new surfaces accompanying the generation of fine particles can be suppressed as compared with the case of grinding, and thus the oxygen content is less likely to increase.

As a dispersion apparatus used in the dispersion step, for example, a vibration mill is used. The media used in the dispersion apparatus, such as the vibration mill, may be a metal coated with a resin, and examples of the metal material include iron, chromium steel, stainless steel, and steel. The media used in the dispersion apparatus, such as the vibration mill, may be a ceramic coated with a resin, and examples of the ceramic material include inorganic compounds, such as oxides, carbides, nitrides, and borides of metals or nonmetals, and more specifically include alumina, silica, zirconia, silicon carbide, silicon nitride, barium titanate, and glass. Among these, iron and chromium steel are preferable from the viewpoint of high dispersion ability due to high specific gravity, low abrasion due to high hardness, and small influence of abrasion powder containing iron generated by abrasion on the SmFeN-based anisotropic magnetic powder. That is, resin-coated iron media or resin-coated chromium steel media are preferably used in the dispersion apparatus.

Examples of the coating resin include thermoplastic resins, such as nylon 6, nylon 66, nylon 12, polypropylene, polyphenylene sulfide, and polyethylene; thermosetting resins, such as epoxy resins and silicone resins; and combinations thereof. Since a thermoplastic resin can be formed by injection-molding and has higher fluidity than a thermosetting resin, the film thickness can be made thin compared with the case of coating with a thermosetting resin. Therefore, the specific gravity of the media can be increased and the size can be reduced compared with the case of coating with a thermosetting resin. As the thermoplastic resin, nylon, such as nylon 6, nylon 66, or nylon 12, is preferably used. This is because nylon is relatively soft and inexpensive among thermoplastic resins. For example, nylon-coated iron media may be used in the dispersion apparatus. In that case, the SmFeN-based anisotropic magnetic powder can be dispersed while further suppressing generation of fine powder.

The specific gravity of the media used in the dispersion step is preferably 4 or more, and more preferably 5 or more. When the specific gravity is less than 4, the collision energy at the time of dispersion tends to be too small and dispersion tends to be difficult to occur. The upper limit is not particularly limited, but is preferably 8 or less, and more preferably 7.5 or less. The specific gravity of the media used in the dispersion step may be in a range from 6 to 7.5. The resin-coated metal media or the resin-coated ceramic media is, in other words, the media including a core made of metal or ceramic and a resin film coating the core. The thickness of the resin film can be, for example, in a range from 0.1 μm to 5 mm. This can suppress an increase in the diameter of the media and thus is suitable for dispersion of the SmFeN-based anisotropic magnetic powder, and the or of the formed SmFeN-based anisotropic magnetic powder can be improved.

The dispersion step can be performed in the presence of a solvent, but from the viewpoint of suppressing oxidation of the SmFeN-based anisotropic magnetic powder due to components (for example, moisture) contained in the solvent, it is preferably performed in the absence of a solvent.

From the viewpoint of suppressing oxidation of the SmFeN-based anisotropic magnetic powder, the dispersion step is preferably performed in an inert gas atmosphere, such as a nitrogen gas atmosphere or an argon gas atmosphere. The concentration of nitrogen in the nitrogen gas atmosphere may be 90 vol % or more, and is preferably 95 vol % or more. The concentration of argon in the argon gas atmosphere may be 90 vol % or more, and is preferably 95 vol % or more. The inert gas atmosphere may be an atmosphere in which two or more kinds of inert gases, such as nitrogen gas and argon gas, are mixed. The concentration of the inert gas in the inert gas atmosphere may be 90 vol % or more, and is preferably 95 vol % or more.

The diameter of the media is preferably in a range from 2 mm to 100 mm, more preferably in a range from 3 mm to 15 mm, and still more preferably in a range from 3 mm to 10 mm. When the diameter is less than 2 mm, the media are difficult to coat with a resin, and when the diameter exceeds 100 mm, contact with the powder decreases due to the media being large, and dispersion tends to be difficult to occur.

When a vibration mill is used in the dispersion step, with respect to the volume of a vessel in which the SmFeN-based anisotropic magnetic powder and the media are put, for example, the amount of the media can be set in a range from 60 vol % to 70 vol %, and the amount of the SmFeN-based anisotropic magnetic powder can be set in a range from 3 vol % to 20 vol %, and is preferably in a range from 5 vol % to 20 vol %.

### Preparation Step

Before the dispersion step, there is a step of preparing the SmFeN-based anisotropic magnetic powder before dispersion. The step of preparing the SmFeN-based anisotropic magnetic powder before dispersion is, for example, a step of preparing and obtaining the SmFeN-based anisotropic magnetic powder. The SmFeN-based anisotropic magnetic powder before dispersion that is used in the dispersion step can be prepared with reference to, for example, the methods disclosed in JP 2017-117937 A and JP 2021-055188 A. One example of a method of producing the SmFeN-based anisotropic magnetic powder before dispersion will be described below. Note that the SmFeN-based anisotropic magnetic powder before dispersion is a magnetic powder before subjected to the above-described step of dispersion using the resin-coated metal media or the resin-coated ceramic media, and may be subjected to pre-dispersion steps other than the dispersion step.

The SmFeN-based anisotropic magnetic powder before dispersion that is used in the dispersion step can be prepared by a method including a pretreatment step of heat treating an oxide containing Sm and Fe in a reducing gas-containing atmosphere to form a partial oxide; a step of heat treating the partial oxide in the presence of a reducing agent to form alloy particles; a step of nitriding the alloy particles to form a nitride; and a step of washing the nitride to form the SmFeN-based anisotropic magnetic powder before dispersion.

The oxide containing Sm and Fe that is used in the pretreatment step may be prepared by mixing an Sm oxide and an Fe oxide, but can be produced through a step of mixing a solution containing Sm and Fe with a precipitant to form a precipitate containing Sm and Fe (precipitation step), and a step of calcining the precipitate to form an oxide containing Sm and Fe (oxidation step).

### Precipitation Step

In the precipitation step, a solution containing Sm and Fe is prepared by dissolving an Sm raw material and an Fe raw material in a strongly acidic solution. When Sm₂Fe₁₇N₃ is formed as the main phase, the molar ratio of Sm and Fe (Sm:Fe) is preferably 1.5:17 to 3.0:17, and more preferably 2.0:17 to 2.5:17. A raw material, such as La, W, Co, Ti, Sc, Y, Pr, Nd, Pm, Gd, Tb, Dy, Ho, Er, Tm, or Lu, may be added to the above-described solution. From the viewpoint of residual magnetic flux density, La is preferably contained. From the viewpoint of coercive force and squareness ratio, W is preferably contained. From the viewpoint of temperature characteristics, Co and Ti are preferably contained.

The Sm raw material and the Fe raw material are not limited as long as they can be dissolved in the strongly acidic solution. For example, from the viewpoint of availability, examples of the Sm raw material include samarium oxide, and examples of the Fe raw material include FeSO₄. The concentration of the solution containing Sm and Fe can be adjusted, as appropriate, in a range in which the Sm raw material and the Fe raw material are substantially dissolved in the acidic solution. From the viewpoint of solubility, examples of the acidic solution include sulfuric acid.

An insoluble precipitate containing Sm and Fe is formed by reacting the solution containing Sm and Fe with a precipitant. Here, the solution containing Sm and Fe only needs to be a solution containing Sm and Fe when reacted with the precipitant, and, for example, a raw material containing Sm and a raw material containing Fe may be prepared as separate solutions, and each solution may be added dropwise to react with the precipitant. Even when prepared as separate solutions, appropriate adjustment is performed in a range in which each raw material is substantially dissolved in the acidic solution. The precipitant is not limited as long as it is an alkaline solution that reacts with the solution containing Sm and Fe to produce a precipitate. Examples of the precipitant include ammonia water and caustic soda, and caustic soda is preferable.

As the precipitation reaction, a method in which the precipitant and the solution containing Sm and Fe are each added dropwise to a solvent such as water is preferable because the properties of the precipitate particles can be easily adjusted. By appropriately controlling the supply rates, the reaction temperature, the reaction solution concentration, the pH during the reaction, and the like of the precipitant and the solution containing Sm and Fe, a precipitate having a uniform distribution of constituent elements, a narrow particle size distribution, and an arranged powder shape is formed. The magnetic properties of the SmFeN-based anisotropic magnetic powder that is the final product are improved by using such a precipitate. The reaction temperature is preferably in a range from 0° ° C. to 50° C., and more preferably in a range from 35° C. to 45° C. As a total concentration of metal ions, the reaction solution concentration is preferably in a range from 0.65 mol/L to 0.85 mol/L, and more preferably in a range from 0.7 mol/L to 0.85 mol/L. The reaction pH is preferably in a range from 5 to 9, and more preferably in a range from 6.5 to 8.

From the viewpoint of magnetic properties, the solution containing Sm and Fe preferably further contains one or more metals selected from the group consisting of La, W, Co, and Ti. For example, La is preferably contained from the viewpoint of residual magnetic flux density, W is preferably contained from the viewpoint of coercive force and squareness ratio, and Co and Ti are preferably contained from the viewpoint of temperature characteristics. An La raw material is not limited as long as it can be dissolved in a strongly acidic solution, and from the viewpoint of availability, examples thereof include La₂O₃ and LaCl₃. In addition to the Sm raw material and the Fe raw material, the La raw material, a W raw material, a Co raw material, and a Ti raw material are appropriately adjusted in a range in which they are substantially dissolved into an acidic solution, and from the viewpoint of solubility, sulfuric acid is used as the acidic solution. Examples of the W raw material include ammonium tungstate, examples of the Co raw material include cobalt sulfate, and examples of the Ti raw material include titania sulfate.

When the solution containing Sm and Fe further contains one or more metals selected from the group consisting of La, W, Co, and Ti, an insoluble precipitate containing Sm, Fe and one or more selected from the group consisting of La, W, Co, and Ti is formed. Here, the solution needs to contain one or more selected from the group consisting of La, W, Co, and Ti at the time of reaction with the precipitant, and for example, each raw material may be prepared as a separate solution and each solution may be added dropwise to react with the precipitant, or may be adjusted together with the solution containing Sm and Fe.

The powder particle size, powder shape, and particle size distribution of the SmFeN-based anisotropic magnetic powder that is finally obtained is generally determined by the powder formed in the precipitation step. When the particle size of the formed powder is measured using a laser diffraction-type wet particle size distribution meter, the powder preferably has a size and distribution such that the particle size of all of the powder is substantially within a range from 0.05 μm to 20 μm, and preferably within a range from 0.1 μm to 10 μm.

After the precipitate is separated, the solvent is preferably removed from the separated product, in order to suppress aggregation of the precipitate and changes in the particle size distribution, the particle size of the powder, or the like when the precipitate is redissolved in the remaining solvent and the solvent evaporates in the heat treatment of the subsequent oxidation step. When, for example, water is used as the solvent, a specific example of the method for removing the solvent is drying in an oven at a temperature in a range from 70° C. to 200° ° C. for a period in a range from 5 hours to 12 hours.

After the precipitation step, steps of separating and washing the resulting precipitate may be included. The washing step is appropriately performed until the conductivity of a supernatant solution becomes 5 mS/m² or less. As the step of separating the precipitate, for example, a filtration method, a decantation method, or the like can be used after a solvent (preferably water) is added to the formed precipitate and mixed.

### Oxidation Step

The oxidation step is a step of calcining the precipitate formed in the precipitation step to form an oxide containing Sm and Fe. For example, the precipitate can be converted to an oxide by heat treatment. When the precipitate is subjected to heat treatment, the heat treatment must be implemented in the presence of oxygen, and for example, the heat treatment can be performed in an air atmosphere. Also, because the heat treatment must be performed in the presence of oxygen, oxygen atoms are preferably contained in a non-metal portion in the precipitate.

The heat treatment temperature (hereinafter, oxidation temperature) in the oxidation step is not particularly limited, but is preferably in a range from 700° C. to 1300° C., and more preferably in a range from 900° ° C. to 1200° ° C. At lower than 700° C., the oxidation is insufficient, and at higher than 1300° C., the targeted shape, the targeted average particle size, and the targeted particle size distribution of the SmFeN-based anisotropic magnetic powder tend not to be obtained. The heat treatment time is also not particularly limited, but is preferably in a range from 1 hour to 3 hours.

The formed oxide is oxide particles in which Sm and Fe are sufficiently mixed microscopically, and the shape, the particle size distribution, and the like of the precipitate are reflected.

### Pretreatment Step

The pretreatment step is a step of heat treating the above-described oxide containing Sm and Fe in a reducing gas-containing atmosphere to form a partial oxide in which a portion of the oxide is reduced.

Here, the partial oxide refers to an oxide in which a portion of the oxide is reduced. The oxygen concentration in the partial oxide is not particularly limited, but is preferably 10 mass % or less, and more preferably 8 mass % or less. When the oxygen concentration exceeds 10 mass %, the generation of heat in reduction with Ca increases in the reduction step, and the calcining temperature increases, whereby particles with abnormal particle growth tend to be formed. Here, the oxygen concentration of the partial oxide can be measured by a non-dispersive infrared absorption method (ND-IR).

The reducing gas is selected, as appropriate, from hydrogen (H₂), carbon monoxide (CO), hydrocarbon gases, such as methane (CH₄), a combination of these, and the like, and in terms of cost, hydrogen gas is preferable. The flow rate of the gas is adjusted, as appropriate, within a range in which the oxide does not scatter. The heat treatment temperature (hereinafter, pretreatment temperature) in the pretreatment step is preferably in a range from 300° C. to 950° C., and the lower limit is more preferably 400° C. or higher, and still more preferably 750° ° C. or higher. The upper limit is more preferably less than 900° C. When the pretreatment temperature is 300° C. or higher, the reduction of the oxide containing Sm and Fe proceeds efficiently. When the pretreatment temperature is 950° C. or lower, particle growth and segregation of the oxide particles can be suppressed, and the desired particle size can be maintained. The heat treatment time is not particularly limited, but can be in a range from 1 hour to 50 hours. Additionally, when hydrogen is used as the reducing gas, preferably, the thickness of the oxide layer that is used is adjusted to 20 mm or less, and the dew point in the reaction furnace is adjusted to −10° C. or lower.

### Reduction Step

The reduction step is a step of heat treating the partial oxide in the presence of a reducing agent to form alloy particles, and for example, reduction is performed by bringing the partial oxide into contact with molten calcium or calcium vapor. From the perspective of magnetic properties, the heat treatment temperature is preferably in a range from 920° C. to 1200° C., more preferably in a range from 950° ° C. to 1150° C., and still more preferably in a range from 980° C. to 1100° C.

As heat treatments different from the above-described heat treatment in the reduction step, a heat treatment may be performed at a first temperature in a range from 1000° C. to 1090° C., and subsequently a heat treatment may be performed at a second temperature in a range from 980° ° C. to 1070° C., which is lower than the first temperature. The first temperature is preferably in a range from 1010° ° C. to 1080° C., and the second temperature is preferably in a range from 990° C. to 1060° C. Regarding the temperature difference between the first temperature and the second temperature, the second temperature is preferably lower than the first temperature by a range from 15° C. to 60° C., and more preferably by a range from 15° C. to 30° C. The heat treatment at the first temperature and the heat treatment at the second temperature may be performed successively. Although a heat treatment at a temperature lower than the second temperature may be included between these heat treatments, it is preferable to perform the heat treatments successively from the viewpoint of productivity. From the perspective of more uniformly performing the reduction reaction, each heat treatment time is preferably less than 120 minutes, and more preferably less than 90 minutes, and the lower limit of the heat treatment time is preferably 10 minutes or longer, and more preferably 30 minutes or longer.

Metal calcium as a reducing agent is used in a granular or powdered form, and the average particle size of the metal calcium is preferably 10 mm or less. This can suppress aggregation during the reduction reaction more effectively. Furthermore, the metal calcium is preferably added at a proportion of 1.1 times to 3.0 times the reaction equivalent (the stoichiometric amount required to reduce a rare earth oxide, and when an Fe element is in the form of an oxide, the reaction equivalent includes the amount necessary to reduce the Fe oxide), and more preferably added at a proportion of 1.5 times to 2.5 times the reaction equivalent.

In the reduction step, a disintegration accelerator can be used as necessary along with metal calcium, which is a reducing agent. This disintegration accelerator is used, as appropriate, to promote disintegration and granulation of products during a post-treatment step described below, and examples of the disintegration accelerator include alkaline earth metal salts, such as calcium chloride, and alkaline earth oxides, such as calcium oxide. These disintegration accelerators are used at a proportion in a range from 1 mass % to 30 mass %, and preferably in a range from 5 mass % to 30 mass %, per samarium oxide.

### Nitriding Step

The nitriding step is a step of performing nitriding treatment on the alloy particles formed in the reduction step to form anisotropic magnetic particles. The particulate precipitate formed in the above-described precipitation step is used; thus, the alloy particles in porous bulk form are obtained in the reduction step. As a result, these particles can be heat treated and nitrided immediately in a nitrogen atmosphere without being subjected to grinding, and thus nitriding can be uniformly implemented.

The heat treatment temperature (hereinafter, nitriding temperature) in the nitriding treatment of the alloy particles is preferably 300° C. to 610° C., and particularly preferably 400° C. to 550° C., and the nitriding treatment is performed after replacing the atmosphere with a nitrogen atmosphere in this temperature range. The heat treatment time only needs to be set to a time that allows the alloy particles to be sufficiently and uniformly nitrided.

The nitriding treatment of the alloy particles can be performed by performing the heat treatment at a first temperature in a range from 400° ° C. to 470° C., and subsequently performing the heat treatment at a second temperature in a range from 480° ° C. to 610° C. When the heat treatment at a high temperature of the second temperature is performed without nitriding at the first temperature, abnormal heat generation occurs due to rapid progress of nitriding, the SmFeN-based anisotropic magnetic powder is decomposed, and the magnetic properties might be significantly reduced. Further, the atmosphere in the nitriding step is preferably substantially a nitrogen-containing atmosphere because the progress of nitriding can be further slowed down.

The term “substantially” as used herein is used in consideration of the fact that elements other than nitrogen are inevitably contained due to incorporation of impurities or the like. The proportion of nitrogen in the atmosphere is, for example, 95% or more, preferably 97% or more, and more preferably 99% or more.

The first temperature during the nitriding step is preferably in a range from 400° ° C. to 470° C., and more preferably in a range from 410° C. to 450° C. When the first temperature is less than 400° C., the progress of nitriding is very slow, and when the first temperature exceeds 470° C., overnitriding or decomposition tends to occur due to heat generation. The heat treatment time at the first temperature is not particularly limited, but is preferably in a range from 1 hour to 40 hours, and more preferably 20 hours or less. When the heat treatment time at the first temperature is less than 1 hour, nitriding might not proceed sufficiently in some cases, and when it exceeds 40 hours, productivity deteriorates.

The second temperature is preferably in a range from 480° ° C. to 610° C., and more preferably in a range from 500° ° C. to 550° C. When the second temperature is less than 480° C., nitriding might not proceed sufficiently in some cases if the particles are large, and when the second temperature exceeds 610° C., overnitriding or decomposition is likely to occur. The heat treatment time at the second temperature is preferably in a range from 15 minutes to 5 hours, and more preferably in a range from 30 minutes to 2 hours. When the heat treatment time at the second temperature is less than 15 minutes, the nitriding might not proceed sufficiently in some cases, and when it exceeds 5 hours, productivity deteriorates.

The heat treatment at the first temperature and the heat treatment at the second temperature may be performed successively. Although a heat treatment at a temperature lower than the second temperature may be included between these heat treatments, it is preferable to perform the heat treatments successively from the viewpoint of productivity.

### Post-Treatment Step

The product formed after the nitriding step includes, in addition to the magnetic particles, a byproduct of CaO, unreacted metal calcium, and the like, and these may be combined in a sintered bulk state. The product formed after the nitriding step can be inserted into cooling water to separate the CaO and metal calcium as a calcium hydroxide (Ca(OH)₂) suspension from the SmFeN-based anisotropic magnetic powder. Furthermore, the remaining calcium hydroxide may be sufficiently removed by washing the SmFeN-based anisotropic magnetic powder with acetic acid or the like. When the product is inserted into water, the oxidation of metal calcium with water and the hydration reaction of by-product CaO cause disintegration, that is pulverization, of the composite reaction product in a sintered bulk form.

### Alkali Treatment Step

The product formed after the nitriding step may be inserted into an alkaline solution. Examples of the alkali solution used in the alkali treatment step include a calcium hydroxide aqueous solution, a sodium hydroxide aqueous solution, and an ammonia aqueous solution. Among them, the calcium hydroxide aqueous solution and the sodium hydroxide aqueous solution are preferable from the viewpoint of wastewater treatment and high pH. In the alkali treatment of the product formed after the nitriding step, since an Sm-rich layer containing a certain amount of oxygen remains and functions as a protective layer, an increase in oxygen concentration due to the alkali treatment is suppressed.

The pH of the alkali solution used in the alkali treatment step is not particularly limited, but is preferably 9 or more, and more preferably 10 or more. When the pH is less than 9, the reaction rate in the formation of calcium hydroxide is high and heat generation is large. Therefore, the oxygen concentration of the finally formed SmFeN-based anisotropic magnetic powder tends to be high.

In the alkali treatment step, the moisture in the SmFeN-based anisotropic magnetic powder formed after the treatment with the alkali solution can be reduced by a method such as decantation, if necessary.

### Acid Treatment Step

After the alkali treatment step, an acid treatment step of further treating with an acid may be included. In the acid treatment step, at least a portion of the above-described Sm-rich layer is removed to reduce the oxygen concentration in the entire magnetic powder. In addition, in the method of the embodiment of the present disclosure, since grinding or the like is not performed, the average particle size of the SmFeN-based anisotropic magnetic powder is small, the particle size distribution is narrow, and fine powder generated by grinding or the like is not contained, and thus it is possible to suppress an increase in the oxygen concentration.

The acid used in the acid treatment step is not particularly limited, and examples thereof include hydrogen chloride, nitric acid, sulfuric acid, and acetic acid. Among them, hydrogen chloride and nitric acid are preferable because no impurities remain.

The amount of the acid that is used in the acid treatment step is preferably in a range from 3.5 parts by mass to 13.5 parts by mass, more preferably in a range from 4 parts by mass to 10 parts by mass with respect to 100 parts by mass of the SmFeN-based anisotropic magnetic powder. When the amount of the acid is less than 3.5 parts by mass, an oxide remains on the surface of the SmFeN-based anisotropic magnetic powder and the oxygen concentration increases. When the amount of the acid exceeds 13.5 parts by mass, reoxidation easily occurs when the SmFeN-based anisotropic magnetic powder is exposed to air and the cost tends to increase because the SmFeN-based anisotropic magnetic powder is dissolved. By setting the amount of the acid in a range from 3.5 parts by mass to 13.5 parts by mass with respect to 100 parts by mass of the SmFeN-based anisotropic magnetic powder, it is possible to coat the surface of the SmFeN-based anisotropic magnetic powder with an Sm-rich layer oxidized to such an extent that reoxidation is less likely to occur when the SmFeN-based anisotropic magnetic powder is exposed to air after the acid treatment. Therefore, the SmFeN-based anisotropic magnetic powder having a low oxygen concentration, a small average particle size, and a narrow particle size distribution is formed.

In the acid treatment step, moisture in the SmFeN-based anisotropic magnetic powder formed after the treatment with the acid can be reduced by a method such as decantation, if necessary.

### Dehydration Step

A step of performing a dehydration treatment is preferably included after the acid treatment step. By the dehydration treatment, it is possible to reduce moisture in the solid content before vacuum drying, and to suppress the progress of oxidation during drying caused by the solid content before vacuum drying containing more moisture. Here, the dehydration treatment means a treatment of reducing a value of moisture contained in a solid content after the treatment with respect to a solid content before the treatment by applying pressure or centrifugal force, and does not include simple decantation, filtration, or drying. The dehydration treatment method is not particularly limited, and examples thereof include squeezing and centrifugal separation.

The moisture contained in the SmFeN-based anisotropic magnetic powder after the dehydration treatment is not particularly limited, but is preferably 13 mass % or less, and more preferably 10 mass % or less from the viewpoint of suppressing the progress of oxidation.

The SmFeN-based anisotropic magnetic powder formed by the acid treatment or the SmFeN-based anisotropic magnetic powder formed by the dehydration treatment after the acid treatment is preferably vacuum-dried. The drying temperature is not particularly limited, but is preferably 70° C. or higher, and more preferably 75° C. or higher. The drying time is also not particularly limited, but is preferably 1 hour or longer, and more preferably 3 hours or longer.

### Surface Treatment Step

The SmFeN-based anisotropic magnetic powder formed in the post-treatment step may be subjected to a surface treatment. For example, a phosphoric acid solution is inserted as a surface treatment agent in a range of 0.10 mass % to 10 mass % of PO₄ with respect to the solid content of the magnetic particles formed in the nitriding step. By appropriately performing separation from the solution and drying, the SmFeN-based anisotropic magnetic powder subjected to the surface treatment is formed.

An SmFeN-based anisotropic magnetic powder according to an aspect of the present disclosure contains Sm, Fe, and N, and has an average particle size in a range from 2.5 μm to 5 μm, a residual magnetization σr of 150 emu/g or more, and an oxygen content of 0.4 mass % or less.

The average particle size of the SmFeN-based anisotropic magnetic powder is in a range from 2.5 μm to 5 μm, and preferably in a range from 2.6 μm to 4.5 μm. When the average particle size is less than 2.5 μm, oxidation is likely to occur due to a large surface area, and when the average particle size exceeds 5 μm, the SmFeN-based anisotropic magnetic powder has a multi-magnetic domain structure, and the magnetic properties tend to be reduced. Here, the average particle size means a particle size measured in dry conditions using a laser diffraction-type particle size distribution measurement device.

A particle size D10 of the SmFeN-based anisotropic magnetic powder is preferably in a range from 0.5 μm to 3 μm, and more preferably in a range from 1 μm to 2 μm. When the particle size D10 is less than 0.5 μm, the filling amount of the SmFeN-based anisotropic magnetic powder in the bonded magnet decreases, and thus magnetization is reduced, and when the particle size D10 exceeds 3 μm, the coercive force of the bonded magnet tends to decrease. Here, D10 is a particle size at which the integrated value of the volume-based particle size distribution of the SmFeN-based anisotropic magnetic powder is equivalent to 10%.

A particle size D50 of the SmFeN-based anisotropic magnetic powder is preferably in a range from 2 μm to 5 μm, and more preferably in a range from 2.5 μm to 4.5 μm. When the average particle size D50 of the SmFeN-based anisotropic magnetic powder is less than 2 μm, the filling amount thereof in the bonded magnet decreases, and thus magnetization is reduced. When the average particle size D50 of the SmFeN-based anisotropic magnetic powder exceeds 5 μm, the coercive force of the bonded magnet tends to decrease. Here, D50 is a particle size at which the integrated value of the volume-based particle size distribution of the SmFeN-based anisotropic magnetic powder is equivalent to 50%.

A particle size D90 of the SmFeN-based anisotropic magnetic powder is preferably in a range from 3 μm to 7 μm, and more preferably in a range from 4.5 μm to 6.5 μm. When the particle size D90 of the SmFeN-based anisotropic magnetic powder is less than 3 μm, the filling amount thereof in the bonded magnet decreases, and thus magnetization is reduced, and when the particle size D90 of the SmFeN-based anisotropic magnetic powder exceeds 7 μm, the coercive force of the bonded magnet tends to decrease. Here, D90 is a particle size at which the integrated value of the volume-based particle size distribution of the SmFeN-based anisotropic magnetic powder is equivalent to 90%.

The residual magnetization σr is 150 emu/g or more, and preferably 151 emu/g or more.

The oxygen content in the SmFeN-based anisotropic magnetic powder is 0.4 mass % or less, preferably 0.38 mass % or less, more preferably 0.3 mass % or less, and particularly preferably 0.25 mass % or less. When the oxygen content in the SmFeN-based anisotropic magnetic powder exceeds 0.4 mass %, a large amount of oxygen is present on the surface of the particles, which causes generation of α-Fe. The analysis of the oxygen content is performed after the SmFeN-based anisotropic magnetic powder formed after the completion of all the steps is left in air for 30 minutes or longer.

The SmFeN-based anisotropic magnetic powder in the present embodiment is typically represented by the following general formula: SmᵥFe_{(100-v-w-x-y-z-u)}N_{w}LaₓW_{y}Co_{z}Tiᵤ (where 3≤v≤30, 5≤w≤15, 0≤x≤0.3, 0≤y≤2.5, 0≤z≤2.5, and 0≤u≤2.5).

In the general formula, v is specified to be in a range from 3 to 30. This is because if v were less than 3, an unreacted portion (α-Fe phase) of the iron component would be separated, the coercive force of the SmFeN-based anisotropic magnetic powder would be reduced, and thus a practical magnet would fail to be provided, and if v exceeded 30, the Sm element would be precipitated, the SmFeN-based anisotropic magnetic powder would become unstable in air, and the residual magnetic flux density would be reduced. In addition, w is specified to be in a range from 5 to 15 because if w were less than 5, the coercive force would hardly be exhibited, and if w exceeded 15, nitrides of Sm and iron itself would be generated.

When La is contained, the La content is preferably in a range from 0.1 mass % to 5 mass %, and more preferably in a range from 0.15 mass % to 1 mass % from the viewpoint of residual magnetic flux density.

When W is contained, the W content is preferably in a range from 0.1 mass % to 5 mass %, and more preferably in a range from 0.15 mass % to 1 mass % from the viewpoint of coercive force and squareness ratio.

When Co is contained, the Co content is preferably in a range from 0.1 mass % to 5 mass %, and more preferably in a range from 0.15 mass % to 1 mass % from the viewpoint of temperature characteristics.

When Ti is contained, the Ti content is preferably in a range from 0.1 mass % to 5 mass %, and more preferably in a range from 0.15 mass % to 1 mass % from the viewpoint of temperature characteristics.

The N content is preferably in a range from 3.3 mass % to 3.5 mass %. When the N content exceeds 3.5 mass %, overnitriding occurs, and when the N content is less than 3.3 mass %, nitriding becomes insufficient. In both cases, the magnetic properties tend to be reduced.

Among them, SmFeN, SmFeLaN, SmFeLaWN, and SmFeLaCON are preferable.

In the following formula of the SmFeN-based anisotropic magnetic powder, Span=(D90−D10)/D50 (where D10, D50, and D90 are particle sizes at which the integrated values of the volume-based particle size distribution are equivalent to 10%, 50%, and 90%, respectively), the span herein is preferably 1.6 or less, and more preferably 1.3 or less. When the span exceeds 1.6, large particles are present, and the magnetic properties tend to be reduced.

The average value of the circularity of the SmFeN-based anisotropic magnetic powder is preferably 0.50 or more, more preferably 0.70 or more, and particularly preferably 0.75 or more. When the circularity is less than 0.50, worsened fluidity causes application of stress between particles during magnetic field molding, and thus the magnetic properties are reduced. For measurement of the circularity, a scanning electron microscope (SEM) is used, and Particle Analysis Ver. 3 manufactured by Sumitomo Metal Technology, Inc is used as image analysis software. By a SEM image captured at 3000× being binarized through image processing, the circularity of one particle is determined. The circularity defined in the present disclosure refers to an average value of circularity determined by measuring approximately 1000 to 10000 particles. In general, the circularity increases as the number of particles having a small particle size increases, and therefore the circularity was measured for particles having a particle size of 1 μm or more. In the measurement of circularity, a definitional equation of circularity=(4πS/L²) is used. Here, S is the two-dimensional projected area of the particle, and L is the two-dimensional projected circumferential length.

Since the SmFeN-based anisotropic magnetic powder of the present embodiment has a high residual magnetization, it can be used as a sintered magnet or a bonded magnet, for example.

The bonded magnet is prepared using the SmFeN-based anisotropic magnetic powder of the present embodiment and a resin. By containing this SmFeN-based anisotropic magnetic powder, a composite material having high magnetic properties can be formed. The method of producing a bonded magnet includes a step of forming the SmFeN-based anisotropic magnetic powder by the method of the present embodiment, and a step of mixing the SmFeN-based anisotropic magnetic powder with a resin. The method of producing the bonded magnet may further include a step of aligning domains of easy magnetization in an orientated magnetic field while heat treating a composite material formed by mixing the SmFeN-based anisotropic magnetic powder with a resin, and subsequently a step of pulse-magnetizing the composite material in a magnetizing field.

The resin contained in the composite material may be a thermosetting resin or a thermoplastic resin, but is preferably a thermoplastic resin. Specific examples of the thermoplastic resin include polyphenylene sulfide resins (PPS), polyether ether ketone (PEEK), liquid crystal polymer (LCP), polyamide (PA), polypropylene (PP), and polyethylene (PE).

The mass ratio of the resin to the SmFeN-based anisotropic magnetic powder (resin/SmFeN-based anisotropic magnetic powder) in forming the composite material is preferably 0.05 to 0.20, more preferably 0.10 to 0.15, and still more preferably 0.11 to 0.14. Also, the filling rate of the SmFeN-based anisotropic magnetic powder in the composite material is preferably 50 vol % to 75 vol %, more preferably 60 vol % to 70 vol %, and still more preferably 65 vol % to 70 vol %.

The composite material can be formed, for example, by mixing the SmFeN-based anisotropic magnetic powder with the resin at a temperature of preferably 200° ° C. to 350° C., more preferably 280° ° C. to 330° ° C., using a kneader.

By using the composite material, the bonded magnet can be produced. Specifically, for example, the bonded magnet can be formed through a step (orientation step) of aligning the domains of easy magnetization in an orientated magnetic field while the composite material is heat treated, and subsequently a step (magnetization step) of performing pulse magnetization in a magnetizing field.

The heat treatment temperature in the orientation step is, for example, preferably 90° C. to 200° C., and more preferably 100° C. to 150° C. The magnitude of the orientated magnetic field in the orientation step can be, for example, 720 kA/m. The magnitude of the magnetizing field in the magnetization step can be, for example, 1500 kA/m to 2500 kA/m.

The method of producing the bonded magnet may include a step of injection-molding the composite material (a compound for a bonded magnet). The molding temperature in the injection-molding is not particularly limited, and can be appropriately set according to the processing temperature of the thermoplastic resin being used.

By preparing a bonded magnet using the SmFeN-based anisotropic magnetic powder of the present embodiment, a bonded magnet having high magnetic properties can be formed. The bonded magnet contains the SmFeN-based anisotropic magnetic powder of the present embodiment and a resin. For example, by preparing a bonded magnet using the SmFeN-based anisotropic magnetic powder of the present embodiment, the squareness ratio Hk of the formed bonded magnet can be improved. The SmFeN-based anisotropic magnetic powder after dispersion might contain fine powder in some cases, but the coercive force iHc tends to increase as the amount of fine powder contained increases, and the squareness ratio Hk also tends to increase as the coercive force iHc increases. However, on the other hand, since the fine powder easily deteriorates by heating, the coercive force iHC and the squareness ratio Hk when a magnet is prepared using the magnetic powder are easily decreased as the proportion of the fine powder contained is increased. For example, the reason why a bonded magnet prepared using the SmFeN-based anisotropic magnetic powder of the present embodiment can have the coercive force iHc and the squareness ratio Hk that are improved as compared with other bonded magnets as in Example 3 and Comparative Example 4 described later is considered to be because the content ratio of the magnetic powder of the SmFeN-based anisotropic magnetic powder of the present embodiment is relatively small.

The bonded magnet may contain PPS as the resin. By using PPS, a bonded magnet having excellent water resistance can be formed. The molding temperature for preparing a bonded magnet using PPS is, for example, 300° ° C. to 340° C. Since the molding temperature of nylon 12 is, for example, 250° C., the molding temperature of PPS can be said to be relatively high. The SmFeN-based anisotropic magnetic powder tends to have lower heat resistance as the proportion of the fine powder increases. Regarding the SmFeN-based anisotropic magnetic powder formed by dispersion using resin-coated metal media or resin-coated ceramic media, fine powder is hardly generated. Therefore, it is suitable for preparation of a bonded magnet using PPS. When PPS is used as the resin, the proportion of fine powder in the SmFeN-based anisotropic magnetic powder to be used, that is, the proportion of the number of the fine powder particles to the total number of particles of the SmFeN-based anisotropic magnetic powder may be 10% or less or 5% or less. The SmFeN-based anisotropic magnetic powder need not contain the fine powder particles. Here, the fine powder particles (fine powder) refer to particles having a particle size of 0.3 μm or less.

The residual magnetic flux density Br of the bonded magnet of the present embodiment can be in a range from 0.80 T to 1.35 T, and may be in a range from 0.90 T to 1 T. The coercive force iHc can be in a range from 7500 Oe to 20000 Oe, and may be in a range from 12200 Oe to 13000 Oe. The squareness ratio Hk can be in a range from 5100 Oe to 20000 Oe, and may be in a range from 7000 Oe to 9000 Oe. The maximum energy product BHmax can be in a range from 16 MGOe to 25 MGOe, and may be in a range from 18 MGOe to 22 MGOe. Hk/iHc can be in a range from 0.55 to 0.90, and may be in a range from 0.70 to 0.80.

The sintered magnet is prepared by molding and sintering the SmFeN-based anisotropic magnetic powder of the present embodiment. The SmFeN-based anisotropic magnetic powder of the present embodiment has a low oxygen concentration, a small average particle size, a narrow particle size distribution, and a high residual magnetic flux density, and thus is suitable for a sintered magnet.

For example, as disclosed in JP 2017-055072 A, a sintered magnet is prepared by sintering a SmFeN-based anisotropic magnetic powder in an atmosphere having an oxygen concentration of 0.5 vol·ppm or less at a temperature of more than 300° C. and less than 600° C., under a pressure in a range from 1000 MPa to 1500 MPa.

For example, as disclosed in WO 2015/199096, a sintered magnet is prepared by pre-compressing a SmFeN-based anisotropic magnetic powder in a magnetic field of 6 kOe or more, and subsequently performing hot compaction at a temperature of 600° ° C. or lower and a molding contact pressure of 1 GPa to 5 GPa.

For example, as disclosed in JP 2016-082175 A, a sintered magnet is prepared by performing a cold compaction of a mixture containing a SmFeN-based anisotropic magnetic powder and a metallic binder at a molding contact pressure of 1 GPa to 5 GPa and subsequently heating the mixture at a temperature of 350° C. to 600° ° C. for 1 minute to 120 minutes.

### EXAMPLES

Hereinafter, examples will be described. Note that unless otherwise specified, “%” is based on mass.

### Evaluation

The content of each metal, the average particle size, the particle size distribution, the nitrogen content, the oxygen content, the residual magnetization σr, the coercive force iHc, and the squareness ratio Hk of the SmFeN-based anisotropic magnetic powder were evaluated by the following methods. The residual magnetic flux density Br, the coercive force iHc, the squareness ratio Hk, and the maximum energy product BHmax of the bonded magnet were evaluated by the following methods.

### Content of Each Metal

The content of each of the metals (such as Sm, Fe, La, and W) in the SmFeN-based anisotropic magnetic powder was measured by an ICP-AES method (apparatus name: Optima 8300) after dissolution in hydrochloric acid.

### Average Particle Size and Particle Size Distribution

The average particle size and the particle size distribution of the SmFeN-based anisotropic magnetic powder were measured with a laser diffraction-type particle size distribution measuring device (HELOS & RODOS manufactured by Japan Laser Corporation).

### Nitrogen Content and Oxygen Content

The nitrogen content and the oxygen content of the SmFeN-based anisotropic magnetic powder were measured by a thermal conductivity method (EMGA-820 manufactured by HORIBA, Ltd.).

Residual Magnetization σr, Coercive Force iHc, and Squareness Ratio Hk of SmFeN-Based Anisotropic Magnetic Powder

A sample vessel is filled with the formed SmFeN-based anisotropic magnetic powder together with paraffin wax, the paraffin wax was melted with a dryer, and then the domains of easy magnetization were aligned in an orientated magnetic field of 16 kA/m. This sample subjected to magnetic field orientation was pulse-magnetized in a magnetizing field of 32 kA/m, and the residual magnetization σr, the coercive force iHc, and the squareness ratio Hk were measured using a vibrating sample magnetometer (VSM) with a maximum magnetic field of 16 kA/m.

Residual Magnetic Flux Density Br, Coercive Force iHc, Squareness Ratio Hk, and Maximum Energy Product BHmax of Bonded Magnet

The residual magnetic flux density Br, the coercive force iHc, the squareness ratio Hk, and the maximum energy product BHmax of the bonded magnet were measured using a BH curve tracer (manufactured by Riken Denshi Co., Ltd.).

### Production Example 1

### Precipitation Step

5.0 kg of FeSO₄·7H₂O was mixed and dissolved in 2.0 kg of pure water. In addition, 0.49 kg of Sm₂O₃, 0.035 kg of La₂O₃, and 0.74 kg of 70% sulfuric acid were added and the mixture was stirred well to be completely dissolved. Subsequently, pure water was added to the formed solution to adjust the solution such that the final Fe concentration was 0.726 mol/L and the final Sm concentration was 0.112 mol/L, whereby an SmFeLa sulfuric acid solution was prepared.

Into 20 kg of pure water maintained at a temperature of 40° C., the full amount of the prepared SmFeLa sulfuric acid solution was added dropwise while stirring was performed for 70 minutes from the start of the reaction, and at the same time, a 15% ammonia solution was added dropwise to adjust the pH to 7 to 8. As a result, a slurry containing SmFeLa hydroxide was formed. The formed slurry was washed with pure water through decantation, after which the hydroxide was solid-liquid separated. The separated hydroxide was dried in an oven at 100° ° C. for 10 hours.

### Oxidation Step

The hydroxide formed in the precipitation step was calcined at 1000° C. in air for 1 hour. After cooling, a red SmFeLa oxide was formed as a raw material powder.

### Pretreatment Step

100 g of the SmFeLa oxide formed in Production Example 1 was put in a steel container such that the bulk thickness was 10 mm. The container was inserted into a furnace, and the pressure was reduced to 100 Pa, after which the temperature was increased to the pretreatment temperature of 850° C. while hydrogen gas was being introduced, and this state was maintained for 15 hours. The oxygen concentration was measured by the non-dispersive infrared absorption method (ND-IR) (using EMGA-820 manufactured by Horiba, Ltd.) and was found to be 5 mass %. Through this, it was found that the oxygen bonded to Sm was not reduced and a black partial oxide in which 95% of the oxygen bonded to Fe was reduced was formed.

### Reduction Step

60 g of the partial oxide formed in the pretreatment step and 19.2 g of metal calcium having an average particle size of approximately 6 mm were mixed and inserted into a furnace. The inside of the furnace was evacuated to create a vacuum state, after which argon gas (Ar gas) was introduced. The temperature was increased to a first temperature of 1045° C. and this state was maintained for 45 minutes. Subsequently, the temperature was cooled to a second temperature of 1000° C., and this state was maintained for 30 minutes. Consequently, the SmFeLa alloy particles were formed.

### Nitriding Step

After the temperature inside the furnace was cooled to 100° C., the furnace was evacuated to create a vacuum state, and while nitrogen gas was being introduced, the temperature was increased to a first temperature of 430° C. and that state was maintained for 3 hours. Subsequently, the temperature was increased to a second temperature of 500° C., maintained for 1 hour, and then cooled to form a bulk-formed product containing magnetic particles.

### Post-Treatment Step

The product in a bulk form formed in the nitriding step was inserted into 3 kg of pure water and the mixture was stirred for 30 minutes. The formed solution was left standing, after which the supernatant was drained by decantation. The process of insertion into pure water, stirring, and decantation was repeated 10 times. Subsequently, 2.5 g of 99.9% acetic acid is inserted, and the mixture is stirred for 15 minutes. The formed solution was left standing, after which the supernatant was drained by decantation. The process of insertion into pure water, stirring, and decantation was repeated twice. After solid-liquid separation, vacuum drying was performed at 80° C. for 3 hours to form a SmFeN-based anisotropic magnetic powder.

### Production Example 2

### Precipitation Step

5.0 kg of FeSO₄·7H₂O was mixed and dissolved in 2.0 kg of pure water. In addition, 0.49 kg of Sm₂O₃, 0.035 kg of La₂O₃, and 0.74 kg of 70% sulfuric acid were added and the mixture was stirred well to be completely dissolved. Subsequently, pure water was added to the formed solution to adjust the solution such that the final Fe concentration was 0.726 mol/L and the final Sm concentration was 0.112 mol/L, whereby an SmFeLa sulfuric acid solution was prepared.

Into 20 kg of pure water maintained at a temperature of 40° C., the full amount of the prepared SmFeLa sulfuric acid solution and 0.14 kg of 18% ammonium tungstate were added dropwise while stirring was performed for 70 minutes from the start of the reaction, and at the same time, a 15% ammonia solution was added dropwise to adjust the pH to 7 to 8. As a result, a slurry containing SmFeLa hydroxide was formed. The formed slurry was washed with pure water through decantation, after which the hydroxide was solid-liquid separated. The separated hydroxide was dried in an oven at 100° C. for 10 hours.

### Oxidation Step

The hydroxide formed in the precipitation step was calcined at 1000° C. in air for 1 hour. After cooling, a red SmFeLaW oxide was formed as a raw material powder.

By performing the pretreatment step to the post-treatment step in the same manner as that in Production Example 1, a SmFeN-based anisotropic magnetic powder was formed.

### Example 1

### Dispersion Step

The SmFeN-based anisotropic magnetic powder formed in Production Example 1 and media (nylon-coated iron core media, diameter: 10 mm, Vickers constant of a nylon in coated portion: 7, specific gravity: 7.48, nylon layer thickness: approximately 1 mm to 3 mm) were put in a vessel to be used in a vibration mill, such that the amount of the SmFeN-based anisotropic magnetic powder was 5 vol % and the amount of the media was 60 vol % with respect to the volume of the vessel. Dispersion was performed for 30 minutes in a nitrogen atmosphere using the vibration mill to form a SmFeN-based anisotropic magnetic powder.

### Example 2

### Dispersion Step

The SmFeN-based anisotropic magnetic powder formed in Production Example 2 and the media (nylon-coated iron core media, diameter: 10 mm, Vickers constant of nylon in coated portion: 7, specific gravity: 7.48, nylon layer thickness: approximately 1 mm to 3 mm) were put in a vessel to be used in a vibration mill, such that the amount of the SmFeN-based anisotropic magnetic powder was 5 vol % and the amount of the media was 60 vol % with respect to the volume of the vessel. Dispersion was performed for 30 minutes in a nitrogen atmosphere using the vibration mill to form a SmFeN-based anisotropic magnetic powder.

### Comparative Example 1

The SmFeN-based anisotropic magnetic powder formed in Production Example 1 and media (chromium steel balls; SUJ2, diameter: 2.3 mm, Vickers constant: 760, specific gravity: 7.77) were put in a vessel to be used in a vibration mill, such that the amount of the SmFeN-based anisotropic magnetic powder was 5 vol % and the amount of the media was 60 vol % with respect to the volume of the vessel. Dispersion was performed for 60 minutes in a nitrogen atmosphere using the vibration mill to form a SmFeN-based anisotropic magnetic powder.

### Comparative Example 2

The SmFeN-based anisotropic magnetic powder formed in Production Example 2 and the media (chromium steel balls; SUJ2, diameter: 2.3 mm, Vickers constant: 760, specific gravity: 7.77) were put in a vessel to be used in a vibration mill, such that the amount of the SmFeN-based anisotropic magnetic powder was 5 vol % and the amount of the media was 60 vol % with respect to the volume of the vessel. Dispersion was performed for 60 minutes in a nitrogen atmosphere using the vibration mill to form a SmFeN-based anisotropic magnetic powder.

### Comparative Example 3

The SmFeN-based anisotropic magnetic powder formed in Production Example 2 and media (made of nylon, diameter: 10 mm, Vickers constant: 7, specific gravity: 1.13) were put in a vessel to be used in a vibration mill, such that the amount of the SmFeN-based anisotropic magnetic powder was 5 vol % and the amount of the media was 60 vol % with respect to the volume of the vessel. Dispersion was performed for 60 minutes in a nitrogen atmosphere using the vibration mill to form a SmFeN-based anisotropic magnetic powder.

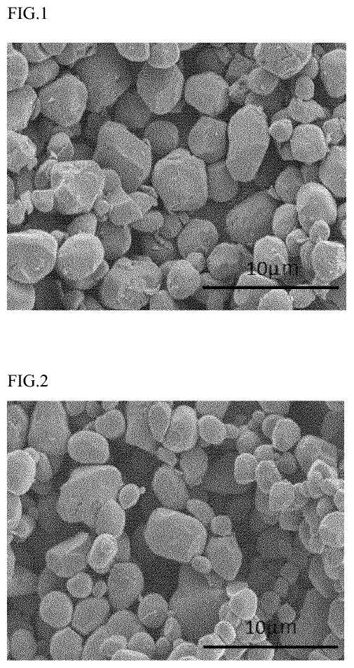

For the SmFeN-based anisotropic magnetic powders formed in Example 1, Example 2, and Comparative Example 1 to Comparative Example 3, the average particle size, the particle size distribution, the residual magnetization σr, the coercive force iHc, the squareness ratio Hk, the oxygen concentration, and the nitrogen concentration were measured by the above-described methods. The results of the measurements are shown in Table 1, and the results of measuring the content of each metal are shown in Table 2. Images of the magnetic powders formed in Example 1, Example 2, Comparative Example 1, and Comparative Example 2 were captured with a scanning electron microscope (SU3500, manufactured by Hitachi High-Technologies Corporation, 5 KV, 5000×). The results thereof are shown in FIGS. 1 to 4.

TABLE 1

| | | | | | | | | | | O | N |
|---|---|---|---|---|---|---|---|---|---|---|---|
| | Particle | | | | | Circ | σr | | | Concen- | Concen- |
| Example | Size | D10 | D50 | D90 | | (Circu- | (emu/ | iHc | Hk | tration | tration |
| Number | (μm) | (μm) | (μm) | (μm) | Span | larity) | g) | (Oe) | (Oe) | (%) | (%) |
| Example 1 | 3.93 | 2.05 | 3.77 | 5.94 | 1.03 | 0.813 | 153.8 | 7865 | 3428 | 0.21 | 3.34 |
| Example 2 | 3.10 | 1.58 | 2.90 | 4.78 | 1.10 | 0.828 | 152.2 | 10570 | 4751 | 0.37 | 3.39 |
| Comparative | 3.58 | 1.81 | 3.48 | 5.51 | 1.06 | 0.808 | 148.3 | 7980 | 3027 | 0.33 | 3.33 |
| Example 1 | | | | | | | | | | | |
| Comparative | 2.79 | 1.40 | 2.69 | 4.26 | 1.06 | 0.830 | 148.9 | 11750 | 5431 | 0.46 | 3.40 |
| Example 2 | | | | | | | | | | | |
| Comparative | 4.40 | 2.42 | 4.18 | 6.50 | 0.98 | 0.817 | 139.8 | 7483 | 2357 | 0.18 | 3.37 |
| Example 3 | | | | | | | | | | | |

TABLE 2

| Example | Content Rate (%) | | | | | Composition Formula | | | | |
|---|---|---|---|---|---|---|---|---|---|---|
| Number | Sm | Fe | N | La | W | Sm | Fe | N | La | W |
| Example 1 | 22.7 | 74.0 | 3.34 | 0.30 | | 8.8 | 77.2 | 13.9 | 0.1 | |
| Example 2 | 23.0 | 72.8 | 3.39 | 0.35 | 0.52 | 9.0 | 76.5 | 14.2 | 0.1 | 0.2 |
| Com- | 23.7 | 73.0 | 3.33 | 0.47 | | 9.2 | 76.6 | 13.9 | 0.2 | |
| parative | | | | | | | | | | |
| Example 1 | | | | | | | | | | |
| Com- | 22.7 | 75.8 | 3.40 | 0.31 | 0.42 | 8.6 | 77.3 | 13.8 | 0.1 | 0.1 |
| parative | | | | | | | | | | |
| Example 2 | | | | | | | | | | |
| Com- | 22.8 | 73.1 | 3.37 | 0.40 | | 8.9 | 76.8 | 14.1 | 0.2 | |
| parative | | | | | | | | | | |
| Example 3 | | | | | | | | | | |

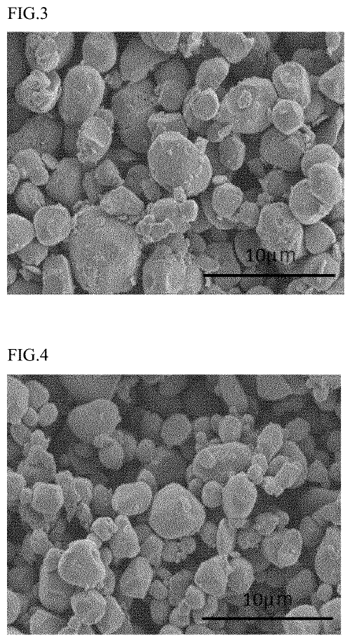

It was confirmed that, in Examples 1 and 2 in which an iron core coated with a nylon resin was used as the media for dispersion, the residual magnetization was higher than that in Comparative Examples 1 and 2 in which chromium steel balls not coated with a resin were used as the media for dispersion and Comparative Example 3 in which a nylon resin was used as the media for dispersion. Also, in Comparative Examples 1 and 2, as shown in FIGS. 3 and 4, the amount of fine powder particles of the magnetic powder was large, whereas in Example 1 and Example 2, the amount thereof was relatively small.

### Example 3

Into 100 parts by mass of the SmFeN-based anisotropic magnetic powder formed in Example 1, 6.6 parts by mass of nylon 12 was mixed by a mixer. The formed mixed powder was kneaded at 210° C. using a twin-screw kneader to form a compound for a bonded magnet as a composite material. The compound for a bonded magnet was injection-molded at a molding temperature of 250° C. using an injection-molding machine to prepare a bonded magnet.

### Example 4

A bonded magnet was prepared in the same manner as that in Example 3 except that the SmFeN-based anisotropic magnetic powder formed in Example 2 was used as the SmFeN-based anisotropic magnetic powder.

### Example 5

A bonded magnet was prepared in the same manner as that in Example 4 except that the molding temperature was 230° C.

### Example 6

Into 100 parts by mass of the SmFeN-based anisotropic magnetic powder formed in Example 2, 11 parts by mass of a polyphenylene sulfide resin was mixed by a mixer. The formed mixed powder was kneaded at 310° C. using a twin-screw kneader to form a compound for a bonded magnet as a composite material. The compound for a bonded magnet was injection-molded at a molding temperature of 310° ° C. using an injection-molding machine to prepare a bonded magnet.

### Comparative Example 4

Into 100 parts by mass of the SmFeN-based anisotropic magnetic powder formed in Comparative Example 1, 6.9 parts by mass of nylon 12 was mixed by a mixer. The formed mixed powder was kneaded at 210° C. using a twin-screw kneader to form a compound for a bonded magnet as a composite material. The compound for a bonded magnet was injection-molded at a molding temperature of 250° C. using an injection-molding machine to prepare a bonded magnet.

### Comparative Example 5

A bonded magnet was prepared in the same manner as that in Comparative Example 4 except that the SmFeN-based anisotropic magnetic powder formed in Comparative Example 2 was used as the SmFeN-based anisotropic magnetic powder.

### Comparative Example 6

Into 100 parts by mass of the SmFeN-based anisotropic magnetic powder formed in Comparative Example 2, 13.9 parts by mass of a polyphenylene sulfide resin was mixed by a mixer. The formed mixed powder was kneaded at 310° C. using a twin-screw kneader to form a compound for a bonded magnet as a composite material. The compound for a bonded magnet was injection-molded at a molding temperature of 310° C. using a mold to prepare a bonded magnet.

For the bonded magnets formed in Example 3 to Example 6 and Comparative Example 4 to Comparative Example 6, the residual magnetic flux density Br, the coercive force iHc, the squareness ratio Hk, and the maximum energy product BHmax were measured by the above-described methods. The results of the measurements are shown in Table 3. Table 3 also shows the filling amount of the magnetic powder, the injection pressure during molding, and Hk/iHc.

TABLE 3

| | Molding | Filling | Injection | | | | | |
|---|---|---|---|---|---|---|---|---|
| Example | Temperature | Amount | Pressure | Br | IHc | Hk | BHmax | Hk/ |
| Number | (° C.) | (vol %) | (Mpa) | (T) | (Oe) | (Oe) | (MGOe) | iHc |
| Example 3 | 250 | 65 | 148 | 0.91 | 9010 | 5275 | 18.72 | 0.59 |
| Example 4 | 250 | 65 | 117 | 0.93 | 10881 | 7683 | 20.59 | 0.71 |
| Example 5 | 230 | 65 | 191 | 0.93 | 12586 | 8822 | 20.60 | 0.70 |
| Example 6 | 310 | 60 | 115 | 0.84 | 7690 | 5363 | 16.90 | 0.70 |
| Comparative | 250 | 64 | 175 | 0.89 | 9531 | 4639 | 17.07 | 0.49 |
| Example 4 | | | | | | | | |
| Comparative | 250 | 64 | 180 | 0.87 | 12198 | 6482 | 17.39 | 0.53 |
| Example 5 | | | | | | | | |
| Comparative | 310 | 55 | 230 | 0.72 | 11688 | 5079 | 11.80 | 0.43 |
| Example 6 | | | | | | | | |

It was confirmed that, in Examples 3 to 6 in which the bonded magnets were made using the SmFeN-based anisotropic magnetic powders of Example 1 and Example 2, the residual magnetic flux density and the maximum energy product were higher than in Comparative Examples 4 to 6 in which the bonded magnets were made using the SmFeN-based anisotropic magnetic powders of Comparative Example 1 and Comparative Example 2.

### INDUSTRIAL APPLICABILITY

The SmFeN-based anisotropic magnetic powder formed by the method of the present disclosure has a low oxygen concentration and excellent magnetic properties, and thus can be suitably applied to a bonded magnet and a sintered magnet.

The present disclosure (1) is a method of producing a SmFeN-based anisotropic magnetic powder including: preparing a SmFeN-based anisotropic magnetic powder before dispersion containing Sm, Fe, and N; and dispersing the SmFeN-based anisotropic magnetic powder before dispersion using resin-coated metal media or resin-coated ceramic media.

The present disclosure (2) is the method of producing a SmFeN-based anisotropic magnetic powder, according to the present disclosure (1), in which the media have a specific gravity of 4 or more.

The present disclosure (3) is the method of producing a SmFeN-based anisotropic magnetic powder, according to the present disclosure (1) or (2), in which the dispersing is performed in the absence of a solvent.

The present disclosure (4) is the method of producing a SmFeN-based anisotropic magnetic powder, according to any one of the present disclosures (1) to (3), in which the preparing a SmFeN-based anisotropic magnetic powder before dispersion includes: a pretreatment of heat treating an oxide containing Sm and Fe in a reducing gas-containing atmosphere to obtain a partial oxide; heat treating the partial oxide in the presence of a reducing agent to obtain alloy particles; nitriding the alloy particles to obtain a nitride; and washing the nitride to obtain the SmFeN-based anisotropic magnetic powder before dispersion.

The present disclosure (5) is the method of producing a SmFeN-based anisotropic magnetic powder, according to any one of the present disclosures (1) to (4), in which the SmFeN-based anisotropic magnetic powder further contains La.

The present disclosure (6) is the method of producing a SmFeN-based anisotropic magnetic powder, according to the present disclosure (5), in which the SmFeN-based anisotropic magnetic powder further contains W.

The present disclosure (7) is a method of producing a bonded magnet including: forming a SmFeN-based anisotropic magnetic powder by the method according to any one of the present disclosures (1) to (6); and mixing the SmFeN-based anisotropic magnetic powder with a resin.

The present disclosure (8) is the method of producing a bonded magnet, according to the present disclosure (7), in which the resin is a polyphenylene sulfide resin.

The present disclosure (9) is a SmFeN-based anisotropic magnetic powder containing Sm, Fe, and N and having an average particle size in a range of 2.5 μm to 5 μm, a residual magnetization σr that is 150 emu/g or more, and an oxygen content that is 0.4 mass % or less.

The present disclosure (10) is a bonded magnet containing the SmFeN-based anisotropic magnetic powder according to the present disclosure (9) and a resin.

The present disclosure (11) is the bonded magnet according to the present disclosure (10) in which the resin is a polyphenylene sulfide resin.

What is claimed is:

1-9. (canceled)

10. A method of producing a SmFeN-based anisotropic magnetic powder, comprising:
preparing a SmFeN-based anisotropic magnetic powder before dispersion containing Sm, Fe, and N; and
dispersing the SmFeN-based anisotropic magnetic powder before dispersion using resin-coated metal media or resin-coated ceramic media in a dispersion apparatus to obtain the SmFeN-based anisotropic magnetic powder.

11. The method of producing a SmFeN-based anisotropic magnetic powder, according to claim 10, wherein the resin-coated metal media or the resin-coated ceramic media have a specific gravity of 4 or more.

12. The method of producing a SmFeN-based anisotropic magnetic powder, according to claim 10, wherein the dispersing is performed in the absence of a solvent.

13. The method of producing a SmFeN-based anisotropic magnetic powder, according to claim 10, wherein
the procedure of preparing the SmFeN-based anisotropic magnetic powder before dispersion includes:
heat treating an oxide containing Sm and Fe in a reducing gas-containing atmosphere to obtain a partial oxide;
heat treating the partial oxide in the presence of a reducing agent to obtain alloy particles;
nitriding the alloy particles to obtain a nitride; and
washing the nitride to obtain the SmFeN-based anisotropic magnetic powder before dispersion.

14. The method of producing a SmFeN-based anisotropic magnetic powder, according to claim 10, wherein the SmFeN-based anisotropic magnetic powder further contains La.

15. A method of producing a SmFeN-based anisotropic magnetic powder, comprising:
preparing a SmFeN-based anisotropic magnetic powder before dispersion containing Sm, Fe, and N; and
dispersing the SmFeN-based anisotropic magnetic powder before dispersion using resin-coated metal media to obtain a SmFeN-based anisotropic magnetic powder,
wherein the resin-coated metal media includes a metal core, and
wherein a material of the metal core include at least one selected from the group consisting of iron, chromium steel, stainless steel, and steel.

16. The method of producing a SmFeN-based anisotropic magnetic powder, according to claim 15, wherein the resin-coated metal media have a specific gravity of 4 or more.

17. The method of producing a SmFeN-based anisotropic magnetic powder, according to claim 15, wherein the dispersing is performed in the absence of a solvent.

18. The method of producing a SmFeN-based anisotropic magnetic powder, according to claim 15, wherein
the procedure of preparing the SmFeN-based anisotropic magnetic powder before dispersion includes:
heat treating an oxide containing Sm and Fe in a reducing gas-containing atmosphere to obtain a partial oxide;
heat treating the partial oxide in a presence of a reducing agent to obtain alloy particles;
nitriding the alloy particles to obtain a nitride; and
washing the nitride to obtain the SmFeN-based anisotropic magnetic powder before dispersion.

19. The method of producing a SmFeN-based anisotropic magnetic powder, according to claim 15, wherein the SmFeN-based anisotropic magnetic powder further contains La.

20. A method of producing a bonded magnet, comprising:
forming a SmFeN-based anisotropic magnetic powder by the method according to claim 10; and
mixing the SmFeN-based anisotropic magnetic powder with a resin.

21. The method of producing a bonded magnet, according to claim 20, wherein the resin is a polyphenylene sulfide resin.

22. A method of producing a bonded magnet, comprising:
forming a SmFeN-based anisotropic magnetic powder by the method according to claim 15; and
mixing the SmFeN-based anisotropic magnetic powder with a resin.

23. The method of producing a bonded magnet, according to claim 22, wherein the resin is a polyphenylene sulfide resin.

24. An SmFeN-based anisotropic magnetic powder containing Sm, Fe, and N and having an average particle size in a range of 2.5 μm to 5 μm, a residual magnetization σr that is 150 emu/g or more, and an oxygen content that is 0.4 mass % or less.

25. A bonded magnet containing the SmFeN-based anisotropic magnetic powder according to claim 24 and a resin.

26. The bonded magnet according to claim 25, wherein the resin is a polyphenylene sulfide resin.
